(19) United States
(12) Patent Application Publication
(10) Pub. No.: US 2023/0198907 A1
(43) Pub. Date: Jun. 22, 2023

(54) METHODS AND SYSTEMS FOR EFFICIENT AND SECURE NETWORK FUNCTION EXECUTION

(71) Applicant: University of Southern California, Los Angeles, CA (US)

(72) Inventors: Barath Raghavan, Los Angeles, CA (US); Ramesh Govindan, Los Angeles, CA (US); Zhuojin Li, Los Angeles, CA (US); Jianfeng Wang, Los Angeles, CA (US)

(21) Appl. No.: 18/082,873

(22) Filed: Dec. 16, 2022

Related U.S. Application Data
(60) Provisional application No. 63/290,376, filed on Dec. 16, 2021.

(51) Int. Cl. H04L 47/125; H04L 41/40; H04L 47/50

(52) U.S. Cl. CPC H04L 47/125; H04L 41/40; H04L 47/50

(57) ABSTRACT

A network function virtualization platform for providing network functions for traffic flow of a network is disclosed. The platform may be added to a Function as a Service (FaaS) network infrastructure. A worker node includes a core executing network functions, a scheduler, and an agent. A first network function includes code for executing the network function and a runtime. An ingress module receives network traffic flow and separates packets for performance of the first network function. A controller is coupled to the ingress module and the agent. The controller controls the ingress module to route the separated packets to the worker node. The scheduler schedules execution of the first network function on the packets. The agent assigns execution of the first network function to the core of the worker node.

### PRIORITY CLAIM

This disclosure claims priority to and the benefit of U.S. Provisional Ser. No. 63/290,376 filed on Dec. 16, 2021. The contents of that application are hereby incorporated in their entirety.

### TECHNICAL FIELD

The present disclosure relates to systems and methods for network function virtualization, and more specifically to a network function virtualization platform that leverages network function chains for efficient provision of network functions.

### BACKGROUND

The following description includes information that may be useful in understanding the present invention. It is not an admission that any of the information provided herein is prior art or relevant to the presently claimed invention, or that any publication specifically or implicitly referenced is prior art.

Network Functions (NFs) today perform a range of processing on traffic from simple processing (e.g., VLAN tunneling) to complex processing (e.g., traffic inference). A network function thus may be a network node that performs functions such as examining and modifying network data packets and flows. Currently, network operators use hardware middleboxes that run network functions to achieve traffic management and security objectives. These middleboxes have proven to be hard to manage and difficult to evolve quickly. Thus, network function virtualization (NFV) is a proposed concept to replace current hardware middleboxes with virtualized, easier-to-manage, software-based network function applications.

NFV systems may concurrently support several potentially-conflicting requirements explored in research such as chaining multiple, possibly-stateful network functions to achieve operator objectives; near-line-rate, high-throughput packet processing; traffic isolation between mutually-untrusted, third-party network functions; latency and throughput service level objective (SLO)-adherence; and ease of manageability.

Unfortunately, no software-based system concurrently satisfies all of these requirements, and thus even after years of research in developing a NFV, a software replacement for current middleboxes has not been developed. As a result, the industry has doubled down on custom hardware solutions and complex and bespoke NFV frameworks.

Cloud computing has demonstrated that easily-managed fast, large-scale, multi-tenant processing with performance objectives can be achieved by scale-out compute on commodity clusters and network hardware, using standard OS abstractions for resource management. A NFV system has similar requirements. Thus, performance, scalability, and isolation are key for a NFV to be production-ready. NFV workloads involve the deployment of chains of one or more NFs from different vendors, in a multi-tenant environment. For this reason, an example NFV may leverage cloud computing infrastructure. The example NFV needs to conform to the Cloud infrastructure for deployability and ease of management.

However, the concept of conforming NFV to Cloud computing has been prevented due to the differences between Cloud computing architecture and NFV. The state-of-the-art in NFV employs clean-slate custom interfaces, runtimes, and control planes; breaks abstraction boundaries for performance; places a greater burden upon the programmer to ensure key properties such as isolation; and leverages specialized hardware to achieve high performance. Such customization of the infrastructure undercuts a key focus of NFV: to eliminate the operational headaches of the hardware-based middlebox era.

Offloading some network function processing to specialized hardware, for example, entails operational complexity. Network function vendors implement network functions as they see fit and make them available as containers or virtual machines (VM)s, giving operators little language or hardware choice. Moreover, these solutions violate some requirements to achieve others. For example, certain existing NFV systems integrate hardware and software to achieve high performance and scalability, but ignore network function isolation. Other systems achieve isolation but require specialized programming language support. Still other systems require network function source code to effect performance optimizations through code analysis. Specifically the NetBricks NFV achieves isolation but fails to provide stateful network function support, third-party compatibility, SLO aware chaining, or failure resilience. The Edge OS NFV achieves isolation and third-party compatibility but fails to achieve stateful network function support, SLO aware chaining, or failure resilience. The Metron NFV achieves stateful network function, but fails to achieve isolation, third-party compatibility, SLO aware chaining, or failure resilience. The SNF NFV achieves isolation, third-party compatibility, and failure resilience, but fails to achieve SLO aware chaining.

The function as a service (FaaS) model closely aligns with the requirements of a NFV. For example, a NFV should execute a modular piece of code such as a network function over discrete units of data (packets). With FaaS, network operators deploy network functions without orchestration and management overheads. Developers write and upload either code or an executable, which is then executed on incoming data. FaaS providers hide the underlying infrastructure from developers, and handle provisioning, executing, scheduling, scaling, and resource accounting of user-defined code.

FaaS comes with built-in scalability and can quickly reclaim unused system resources from idle computing units. FaaS enables extreme efficiency as deployments do not pay for resources that they do not use. Network operators can rely on this cost-efficient deployment and benefit from fine-grained billing when serving dynamic traffic. Finally, FaaS services may be accessed through edge clouds, and may be used to support NFV workloads within a FaaS cluster at the edge.

However, FaaS is not yet suitable for NFV. As one example, current FaaS platforms cannot serve NFV workloads with demanding performance requirements nor do they present abstractions for processing packets. In fact, most existing FaaS platforms do not offer any performance guarantees for underlying applications. They employ non-deterministic scheduling on top of shared resources. This makes them mostly useful for latency-insensitive applications. While executing modular functions, FaaS platforms lack an efficient inter-function communication mechanism and often rely on third-party cloud storage services for inter-function coordination. This introduces new sources of latency and can be extremely cost-inefficient when almost all packets may be transmitted among network functions. For this reason, recent work that has used FaaS for NFV does not support network function chains or SLO-adherence.

Thus there is a need for a NFV platform based on cloud computing infrastructure. There is another need for an NFV platform that may provide isolation, stateful network function support, third-party compatibility, SLO aware chaining, and failure resilience. There is yet another need for a NFV platform that builds upon function as a service (FaaS), the Linux kernel, standard NIC hardware, and OpenFlow switches.

### SUMMARY

In one example, a network function virtualization platform providing network functions for traffic flow of a network is disclosed. The platform includes a worker node including a core executing network functions, a scheduler, and an agent. The platform includes a first network function having code for executing the network function and a runtime. An ingress module receives network traffic flow and separates packets for performance of the first network function. A controller is coupled to the ingress module and the agent. The controller controls the ingress module to route the separated packets to the worker node. The scheduler schedules execution of the first network function on the packets. The agent assigns execution of the first network function to the core of the worker node.

Another disclosed example is a method of performing network functions on traffic flow of a network. Network traffic flow is received via an ingress module and packets are separated for performance of a first network function. The first network function includes code for executing the first network function and a runtime. The ingress module is controlled via a controller to route the separated packets to a worker node. The worker node includes a core executing network functions, a scheduler, and an agent. Execution of the first network function is assigned to the core via the agent. Execution of the first network function on the packets is scheduled. The first network function is executed by the core.

Another disclosed example is a non-transitory computer-readable medium having machine-readable instructions stored thereon, which when executed by a processor, cause the processor to receive network traffic flow and separate packets for performance of a first network function. The first network function includes code for executing the first network function and a runtime. The instructions cause the processor to route the separated packets to a worker node. The worker node includes a core executing network functions, a scheduler, and an agent. The instructions cause the processor to assign execution of the first network function to the core via the agent. The instructions cause the processor to schedule execution of the first network function on the packets and execute the first network function on the core.

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the present invention, when taken in connection with the accompanying drawings and the appended claims.

### BRIEF DESCRIPTION OF DRAWINGS

In order to describe the manner in which the above-recited disclosure and its advantages and features can be obtained, a more particular description of the principles described above will be rendered by reference to specific examples illustrated in the appended drawings. These drawings depict only example aspects of the disclosure, and are therefore not to be considered as limiting of its scope. These principles are described and explained with additional specificity and detail through the use of the following drawings:

FIG. 1A shows a block diagram of a control plane of the example NFV platform, according to an embodiment of the present disclosure;

FIG. 1B shows a block diagram of an example worker of the example NFV platform in FIG. 1A, according to an embodiment of the present disclosure;

FIG. 2 shows a timeline of packets on the worker in FIG. 1B, according to an embodiment of the present disclosure;

FIG. 3 is a pseudo-code listing for scaling network function chains and reclaiming cores performed by the example NFV platform;

FIG. 4 shows a graph depicting throughput with increasing chain length for running a network function chain on a single core when using 80-byte packets;

FIG. 5 shows graphs depicting core usage of network function chains implemented in the example NFV platform compared to those implemented by a known NFV as a function of achieved tail latency;

FIG. 6 shows graphs depicting end-to-end tail latency achieved by network function chains deployed in the example NFV platform as a function of latency SLO;

FIG. 7 shows a graph depicting example end-to-end tail latency achieved under different levels of traffic dynamics;

FIG. 8 shows a graph depicting end-to-end latency common data format (CDF) with SR-IOV on and off;

FIG. 9 shows a graph depicting per-packet cost of copying packets of different sizes;

FIG. 10 shows charts of latency for larger capability NICs that demonstrate the scalability of the example NFV platform;

FIG. 11 shows a table of per-core throughput for the example NFV platform;

FIG. 12 shows a table of overheads under isolation variants showing per chain cycle costs;

FIG. 13 shows a table of chain throughput under different batch settings for the example NFV platform;

FIG. 14 shows a graph depicting tail latency (p99), queue length increase as the per-core packet rate increases;

FIG. 15 shows a table of effects of packet rate estimation on migrating flows;

FIG. 16 shows a table of ingress optimization effects; and

FIG. 17 shows graphs of recovery times from failures in a network function chain executed by the example NFV platform.

### DETAILED DESCRIPTION

Unless defined otherwise, technical and scientific terms used herein have the same meaning as commonly understood by one of ordinary skill in the art to which this invention belongs. One skilled in the art will recognize many methods and materials similar or equivalent to those described herein, which could be used in the practice of the present invention. Indeed, the present invention is in no way limited to the methods and materials specifically described. For example, the Figures primarily illustrate the present invention in the gastrointestinal tract, but as indicated throughout, the disclosed systems and methods can be used for other applications.

In some embodiments, properties such as dimensions, shapes, relative positions, and so forth, used to describe and claim certain embodiments of the invention are to be understood as being modified by the term “about.”

Various examples of the invention will now be described. The following description provides specific details for a thorough understanding and enabling description of these examples. One skilled in the relevant art will understand, however, that the invention may be practiced without many of these details. Likewise, one skilled in the relevant art will also understand that the invention can include many other obvious features not described in detail herein. Additionally, some well-known structures or functions may not be shown or described in detail below, so as to avoid unnecessarily obscuring the relevant description.

The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this Detailed Description section.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations may be depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

The present disclosure relates to an example NFV platform termed “Quadrant” that is based on cloud computing infrastructure. The example NFV Quadrant platform leverages the standard mechanisms and abstractions of cloud computing environments. The example NFV platform builds upon function as a service (FaaS), the Linux kernel, standard NIC hardware, and OpenFlow switches, requiring only minimal additions.

In contrast to prior clean-slate customized NFV platforms, the example Quadrant NFV platform takes a dirty-slate approach, making three kinds of minimal changes or extensions to a FaaS model. First, the example NFV platform extends the FaaS programming model to support processing requests for packets and remote state access for stateful network functions, both requirements for any packet-processing service. Second, the example NFV platform reuses FaaS components to achieve many NFV requirements. The example NFV platform relies on hardware and kernel features to achieve isolation, permitting safe, high-performance, zero-copy networking. The example NFV platform extends existing FaaS monitoring to support SLO-adherent dynamic scaling; and uses the open-source Cloud container orchestration system, Kubernetes, to deploy its services so as not to incur extra management complexity. Third, the example NFV platform has minimal custom extensions to support NFV requirements not well-supported on existing FaaS platforms. Thus, the example NFV platform deploys third-party network functions with an efficient isolation mechanism without losing generality. The example NFV platform runs network function chains with an efficient yet standard scaling mechanism. The example NFV platform also executes network function chains that meet SLO targets.

The example NFV platform uses a containerized network function, together with network interface card (NIC) virtualization and thus ensures that a network function chain can only see its own traffic. The example NFV platform also ensures a stronger form of packet isolation as a network function in a chain can process a packet only after its predecessor network function. It does this by spatially isolating the first network function from the others in the chain using a packet copy. Subsequent network functions can process packets in zero-copy fashion, with temporal isolation enforced by scheduling. This approach is general and transparent to network function implementations and requires no language support.

The example Quadrant NFV platform minimally extends FaaS abstractions to enable them to support NFV workloads. As in existing FaaS implementations, each network function runs in a separate container. Network functions are, however, triggered on packet arrival, not on application level request arrival. The example Quadrant NFV platform builds upon OpenFaaS and leverages Kubernetes so the optimized FaaS infrastructure maintains its compatibility with other applications while meeting the needs of the NFV platform.

The example Quadrant NFV dedicates worker cores to network function chains and uses kernel bypass to deliver packets to the network functions. The example NFV platform uses standard OS interfaces to cooperatively schedule network functions in a chain and to mimic run-to-completion proven to be essential for high NFV performance. Run-to-completion processes a batch of packets. The example Quadrant NFV platform selects batch sizes that satisfy SLOs while minimizing context switch overhead.

In response to changes in traffic, the Quadrant NFV platform auto-scales network function chain instances in a manner that minimizes core usage while preserving latency SLOs. This flexibility allows tenants to trade-off latency for lower cost.

Further, the example Quadrant NFV platform achieves up to 2.31× the per-core throughput of state-of-the-art NFV systems that use alternative isolation mechanisms. Under highly dynamic loads, the example Quadrant NFV platform achieves zero packet losses and is able to satisfy tail latency SLOs. Compared to known highly-optimized NFV systems that do not provide packet isolation and are not designed to satisfy latency SLOs (but are designed to minimize latency), the example Quadrant NFV platform uses slightly more CPU cores (12-32%) while achieving isolation and satisfying latency SLOs. Quadrant's total code base is less than half the size of existing NFV platforms, and just 3% of existing open-source FaaS platforms. The code base of the example Quadrant NFV platform is just over 1000 lines, with the remainder generic to NFV support with FaaS or exploiting existing modularity from current abstractions.

The example Quadrant NFV platform provides a general abstraction for writing user-defined network functions. Most current FaaS platforms employ a RESTful API to handle network events, usually via HTTP. They allow developers to write a customized function as the event handler that takes an event struct as input, parsed from a payload of a HTTP request. This abstraction is not ideal for processing raw packets. Unlike dedicated requests to the FaaS ingress server (via a public IP), the example Quadrant NFV permits each packet to be processed by one or more network functions. To do this without modifying the FaaS programming model, each packet must be encapsulated within a HTTP request payload. This can introduce significant extra overhead.

The example NFV platform modifies the FaaS programming and deployment model minimally to support packet processing. The network function developers can accept a raw packet struct (a pointer to the packet) as an input. A NFV platform user, such as an internet service provider, can assemble a network function chain using these network functions. The customer thus submits the network function chain to the example NFV platform, along with a traffic filter specification for what traffic is to be processed by the chain, and a per-packet latency SLO.

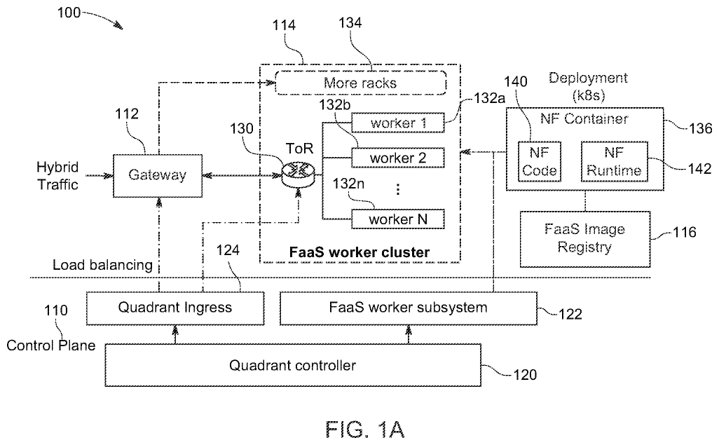

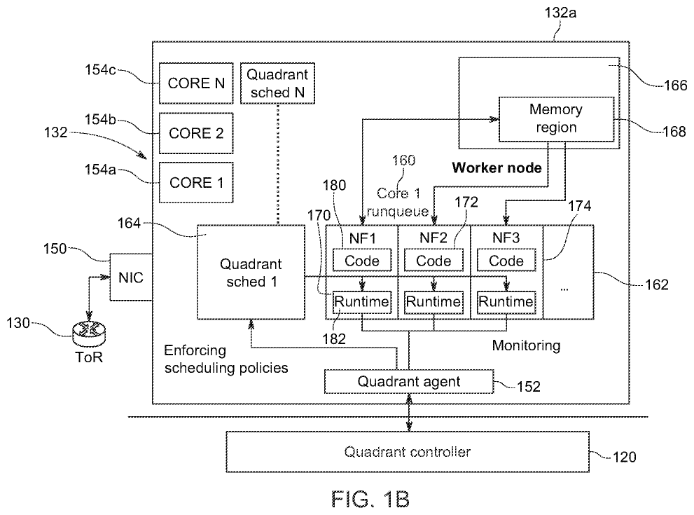

FIG. 1A shows an example NFV platform 100 designated as the Quadrant NFV platform. One typical deployment of the NFV platform may be an Internet Service Provider (ISP) edge. The platform 100 includes a control plane 110, a gateway 112, a worker cluster 114, and a FaaS image registry 116. The gateway 112 represents a system of servers and switches that accepts traffic flowing into the deployment. The control plane 110 includes a controller 120, a FaaS worker subsystem 122, and an ingress module 124. In this example, the control plane 110 may be executed on dedicated commodity servers and OpenFlow switches on the cluster of servers such as one of the machines or servers of the worker cluster 114. The FaaS worker cluster 114 includes a top of rack (ToR) router 130, a set of workers 132a, 132b, 132n. In this example, the worker cluster 114 may be installed on a rack with the TOR router 130 that allows routing of data to the remaining nodes in the worker cluster 114. Additional racks 134 may include additional worker clusters that include additional workers and corresponding TOR routers. A cluster manager such as Kubernetes manages network functions encapsulated in containers 136. In the example NFV platform 100, each container 136 hosts a network function that includes a code 140 for the network function and a network function runtime 142. Customers may provide container images for each network function in the containers 136. The network functions held by the containers are stored by the FaaS image registry 116. Such network functions may be provided or authored by any actor such as the operator or user of the NFV platform 100 or third party vendors for deployment on the platform 100.

The architecture of the example NFV platform 100 reuses existing cloud infrastructure such as servers and OpenFlow-enabled switches. The platform 100 reuses cloud native worker subsystems such as Kubernetes that manage a pool of worker nodes or servers and allocate system resources such as NICs, CPU cores, and memory to network functions. Each worker node executes network functions encapsulated in the containers 136. Alternatively, a virtual machine may encapsulate the network functions, but the containers are faster.

For custom network functions, customers provide container images for each network function. Customers compile and containerize each network function code together with the network function runtime. For third-party network functions, the runtime offers a virtual Ethernet interface (a.k.a. veth) that is an API wrapper for exchanging packets. The Ethernet interface is a standard interface for network functions in production environments. The network functions are ready for deployment once uploaded to the containers 136.

FIG. 1B shows a block diagram of an example worker node such as the worker node 132a of the example NFV platform 100 in FIG. 1A. The example worker node 132a includes a network interface card (NIC) 150 that receives data packets from the ToR 130. The worker node 132a may include multiple processing cores 154(a) to 154(n). An agent 152 enforces scheduling policies and monitors different run queues 160 that are executed by one of the cores such as the core 154a. As will be explained, each of the run queues, such as a run queue 162, includes different network functions that are chained together. A scheduler 164 for the processing core 154a schedules the execution of the network functions. In this example, the run queue 162 includes network functions 170, 172, and 174 that are deployed from the containers 136. It is to be understood that any number of network functions may be provided in the chain of the run queue. The worker node includes a memory 166. As will be explained, each of the network functions in a run queue such as the run queue 162 share a memory region 168 created in the memory 166. Each of the network functions such as the network function 170 includes code 180 to execute function and a runtime 182 to allocate resources to execute network function. In this example, the controller 120 and the ingress module 124 work with the specialized agent 152 and the specific network function runtimes in the worker 132a and incorporate the principles described herein to provide NFV functions. The FaaS worker subsystem 122 and the FaaS image registry 116 are modified from standard FaaS components.

The FaaS worker subsystem 122 may be an existing FaaS worker subsystem for managing worker nodes and deploying services. Worker nodes are a platform for enabling serverless functions to run as close as possible to the end user. In essence, the serverless code itself is “cached” on the network and runs when it receives the right type of request. The worker subsystem 122 in this example may be implemented using Kubernetes in some FaaS implementations. The worker subsystem 122 manages the system resources, i.e., the cluster of worker nodes 114. Each worker machine such as the worker nodes 132a, 132b, executes network functions encapsulated in containers 136. The controller 120 manages the deployment of FaaS services by interacting with the worker subsystem 122 to deploy the NFV components that include the ingress module 124, the scheduler 166 for each agent, and agents on the worker such as the agent 152, prior to startup. Thus, the controller 120 deploys network functions in serving packet processing functions.

At runtime, the controller 120 uses the worker subsystem 122 to deploy network functions from the containers 136 to the worker nodes 132a, 132b, and 132n. The controller 120 collects network function performance statistics from each agent of each of the worker nodes. The controller 120 serves queries from the ingress module 124 or pushes load balancing decisions to the ingress module 124. The ingress module 124 enforces the load balancing decisions by modifying a flow table of the ToR 130. The ingress module 124 is where NFV traffic enters and leaves the system of the example NFV platform 100. The ingress module 124 works with an OpenFlow-enabled switch of the ToR 130 to enforce the workload assignment strategies of the controller 120. Traffic from the OpenFlow-enabled switch of the ToR 130 enters and leaves the system at the ingress module 124. The ingress module 124 forward traffic using flow entries that enforce the workload strategies of the controller 120.

When a new traffic flow arrives at the switch of the gateway 112, packets are forwarded to the ingress module 124. The ingress module 124 determines the target logical network function chain for this flow. To do so, the ingress module 124 queries the controller 120 to pick a network function chain for processing the traffic flow. Alternatively, the ingress module 124 may use prefetched queries. The ingress module 124 then applies the load balancing of the controller 120 for this logical chain to pick a deployed network function chain. Then the ingress module 124 installs a flow rule to offload the flow dispatching task to the switch hardware of the ToR 130. This design reduces traffic sent to the ingress module 124, and thus decreases CPU time spent routing packets. The ingress module 124 routes subsequent packets in the flow to the network function chain for the traffic flow.

The example NFV platform 100 is designed to coexist with normal FaaS processing and thus the ToR switch 130 only passes customer-specified aggregates to the ingress module 124. Traffic that requires application-level processing uses a separate ingress that schedules function execution as in a normal FaaS.

The runtime of the NFV platform 100 works within the constraints of the FaaS framework to achieve performance, scaling, and isolation through careful allocation of worker node NIC and CPU resources, and by careful CPU scheduling.

Prior work has explored different network function execution models that dictate how NFs share packet memory, how the runtimes steer packets to network function s, and how they schedule network function execution. For example, this may be a memory model, a network input/output model, or a CPU scheduling model. Prior work has explored three different models for network functions running on the same worker machine. The network functions may share network function state memory, and packet buffer memory; not share network function state memory, but share packet buffer memory globally; or not share either network function state memory or packet buffer memory.

In known systems, packets may be sent to a specific network function running on a specific server core. In many existing NFV platforms, such as E2, NFVnice, and EdgeOS, a hardware switch forwards packets to specific worker machines. Once packets arrive at the NIC of the server, a virtual switch forwards traffic locally. In a multi-tenant environment, the vSwitch has read and write access to each individual memory space of each network function, and copies packets when forwarding them from an upstream network function to its downstream. The vSwitch can become a bottleneck for both intra- and inter-machine traffic. To scale it up, a runtime can add CPU cores for vSwitches, but cores generate revenue, so this strategy is undesirable. On a test machine, a CPU core can only achieve a 6.9 Gbps throughput when forwarding 64-byte packets (or 13.5 Mpps). For example, a chain with 4 network functions may run on a server with a 10 Gbps NIC. The aggregate traffic volume in this example can reach 40 Gbps at peak on the vSwitch, which requires at least 7 CPU cores to run vSwitches and still more cores if traffic is not evenly distributed across the vSwitches.

An alternative approach is to offload packet switching to the ToR switch and the internal switch of the NIC. Both switches coordinate to ensure packets arrive at the target machine's/target process's memory. When a packet hits the ToR, the switch not only forwards the packet to a dedicated machine, but also facilitates intra-machine forwarding via L2 tagging. This approach eliminates the need to run a vSwitch. However, this approach can only ensure that packets are received by the first network function in a chain. Existing NFV platforms such as Metron and NetBricks take this approach but rely on a strong assumption that all network functions can be compiled and run in a single process. However, many popular network functions are only available in a closed-source form from commercial software developers, and they cannot be compiled with other network functions to form a single binary that runs the network function chain. Even if that were possible, the packet isolation requirement constrains flexibility significantly, since it can only then be achieved using language-level memory isolation.

Memory and network I/O models also impact CPU resource allocation and scheduling of network functions and network function chains. When network function chains run in a single process such as in the existing Metron and NetBricks platforms, those runtimes can dedicate a core to an entire chain. When network functions run in separate processes such as in the existing E2 or NFVnice platforms, runtimes may decide whether to allocate one or more cores to a chain, and how to schedule each network function.

To ensure minimal changes to existing Cloud infrastructures, the example NFV platform chooses an execution model that sits in a different point in the design space. Each network function is deployed in a network function chain as a single container. From the perspective of the underlying FaaS platform, a network function chain represents a “function” (a unit of invocation). The network functions can share packet buffers, but packet isolation is enforced through OS protection, careful scheduling and packet copying. The example NFV platform uses NIC I/O virtualization and kernel bypass to reduce packet steering overhead.

The example NFV platform uses the Data Plane Development Kit (DPDK) for fast userspace networking to handle packet I/O for network functions. Because other FaaS functions may use the kernel networking stack and run on the same worker, the example Quadrant NFV platform may use userspace networking for network function chains while being compatible for kernel networking options. To do so, the example NFV platform 100 uses Single-root Input/Output Virtualization (SR-IOV) to virtualize the NIC hardware. The SR-IOV allows a PCIe device to appear as many physical devices (vNICs). With SR-IOV, the NIC hardware of the NIC 150 generates one Physical Function (PF) that controls the physical device, and many Virtual Functions (VFs) that are lightweight PCIe functions with the necessary hardware access for receiving and transmitting data. The NICs in the example NFV platform 100 do not require complex packet scheduling. Instead, they just dispatch packets based on L2 headers, so simply applying a bandwidth limit to VFs is sufficient to avoid performance isolation. On a worker node such as the node 132a, the agent 152 manages the virtualized NIC devices via kernel APIs through the PF that controls the physical NIC 150.

The ingress module 124 of the example NFV platform 100 maps flows to network function chains. The mapping is thus performed outside the worker node running the chains and the mapping happens at the hardware switch. Before the controller 120 allocates a CPU core to a chain, the agent 152 sets up a virtual function to the chain and pins the chain to its allocated CPU core of the worker. Later, the hardware switch, when matching a flow, rewrites the MAC address of the packet to be the one from the corresponding MAC address of the virtual function. This approach enables outsourcing the computation of dispatching flows and provides a flow-level granularity.

In the example NFV platform 100, the network function runtime on behalf of a network function chain initializes a file-backed dedicated memory region such as the memory region 168 that holds fixed-size packet structures for incoming packets. The runtime also creates a ring buffer that holds packet descriptors that point to the packet structures. To receive packets from the virtualized NIC, the network function runtime passes this ring buffer to its associated virtual function so that the NIC hardware can perform direct memory access (DMA) directly to the memory region of the network function runtime.

For state management of the network functions, stateful network functions such as deduplication, and intrusion detection system (IDS) packet processing, depend on both the packet itself and the current state of the network function. It is feasible to efficiently decouple processing from state. Most stateful network functions only have to access the remote state 1-5 times per connection/flow. In the example NFV platform 100, a scheme to decouple processing from state is implemented by maintaining per-NF global state remotely in memory storage database such as Redis, and provide efficient caching to mitigate the latency overhead of pulling state from the external store. At the front-end, the programming model of the example NFV platform 100 exposes a set of simple APIs for writing a stateful network function. These APIs include an update function (update (flow, val)) and a read function (read (flow, val)), where the flow variable corresponds to a Berkely Packet Filter (BPF) matching rule. Besides the global network function state, the network function runtime of the example NFV platform 100 maintains general network function state in a hash table locally so that the user-defined network function can process most packets with state present in its local memory. The runtime makes the state synchronization transparent to the network function by interacting with the external Redis service. The runtime processes packets in batches, and for each packet batch, the runtime batches all state accesses required by all packets prior to processing. The runtime process pulls state from Redis with a batched read request to amortize the per-packet state access delay. Once a network function calls update, the runtime of the network function issues a request to the local agent such as the agent 152 to update global state in the Redis service and the packet triggering the state update. The agent 152 releases the packet once the global state has been updated. This is necessary to keep network function state consistent. The packet won't reach its destination unless the global state of the network function has been updated. This also avoids performing state synchronization operations in the data plane and prevents the state synchronization from affecting the end-to-end latency.

In the example NFV platform 100, each network function is associated with a unique hash key, which is used to tag network function states in the Redis service. This is useful to recover the state of a single network function instance when migrating flows from it or recovering from failure, as discussed further below.

The state consistency mechanism of the example NFV platform 100 builds on the consistency guarantee of Redis. In Redis, acknowledged writes are committed and never lost and reads return the most-recent committed write. In the example NFV platform 100, a network function emits a packet only after receiving a state update acknowledgement, and starts processing a migrated flow only after emitting packets from the original core. When a network function updates per-flow state, this ensures state consistency.

In the example NFV platform 100, network functions are individual containers deployed in a Kubernetes cluster. The example NFV platform 100 dedicates a core of a worker to a network function chain that actively serves traffic. That core serves a traffic aggregate assigned to that network function chain. When the total traffic exceeds the capacity of a single core, the example NFV platform spins up another network function chain instance on another core, and splits incoming traffic between the network function chain instances. This is appropriate since network function chains will handle large traffic aggregates, so that multiple cores might be necessary to process traffic for a given chain. The controller 120 manages all network functions via Kubernetes APIs to control the allocation of memory, CPU share, and disk space in each worker node in the worker cluster 114.

For controlling network function chain execution, userspace I/O and shared memory can reduce overhead significantly, but to be able to process packets at high throughput and low latency, the example NFV platform 100 has tight control over network function chain execution. As discussed earlier, prior art customized network function platforms use two different approaches. One approach employed by the existing Metron or NetBricks platforms bundles network functions in a network function chain into a single process to run to completion, in which each network function in the chain processes a batch of packets before moving onto the next batch. This approach ensures performance predictability and high performance by amortizing overhead over a packet batch. To achieve packet isolation, NetBricks relies on language isolation. The second approach used by the NFVnice platform, is to run each network function in a separate process, which ensures isolation with copying packets, but can require careful allocation of CPU shares, and orchestration of process execution on the underlying scheduler such as the completely fair scheduler (CFS) used in the NFVnice platform.

In contrast to these two approaches in existing systems, the example NFV platform 100 uses spatiotemporal packet isolation in which network function chains operate on: 1) spatially isolated packet memory regions (as opposed to the typical model in run-to-completion software switches such as the Berkeley-Extensible Software Switch (BESS), in which all network function chains on a node run in the same memory); and 2) are temporally isolated through careful sequencing of their execution, which proceeds in a run-to-completion fashion across processes and uses cooperative scheduling mechanisms to hand off control and the natural execution boundary of packet batch handoff. This isolation ensures that network function chains, which may process traffic from different customers, cannot see other packet streams or state, and even within a chain each network function maintains private state and only gets to execute (and thus access packet memory) when it is expected to perform packet processing in the chain. This process means that developers are not forced to write and release network function code in a specific programming language. This process also avoids overheads and complexity brought by approaches that use vSwitches.

The example NFV platform 100 relies on a per-core cooperative scheduler such as the scheduler 164 to schedule network functions on each core. All network function containers 136 that are part of a network function chain are assigned to a single core such as the core 154a in FIG. 1B. Each network function container runs two processes. The network function process runs in a single-thread for processing traffic. The other process runs the network function runtime, consisting of an RPC server for controlling the behavior of the network function, and a monitoring thread that collects performance statistics. To avoid interfering with packet processing, the monitoring thread runs on a separate core. The runtime is provided by the operator of the example NFV platform and is completely transparent to authors of the network function code.

To tightly coordinate network function chain execution, the example NFV platform 100 uses Linux's real-time (RT) scheduling support and manages real-time priorities of the network functions. The threads are scheduled using a FIFO policy. This policy is used to emulate, as described below, network function chain run-to-completion execution in which each network function in the chain processes a batch of packets in sequence.

The example NFV platform 100 uses cooperative scheduling where an upstream network function runs in a loop to process individual packets of a given batch, and then yields the core to a downstream network function. This is transparent to the network functions, once the user-defined network function finishes processing, it invokes the network function runtime to transmit the batch to the downstream network function. In cases where the network function is non-responsive, the runtime terminates chain execution if a network function fails to yield after a conservative timeout.

For such cooperative scheduling, the cooperative scheduler 164 has to bypass the underlying scheduler and take full control of a core. In this example, the underlying scheduler is the completely fair scheduler (CFS) in Linux, but other schedulers in underlying operating systems may be used. Internally, the cooperative scheduler 164 maintains a run FIFO queue and a wait FIFO queue. The run queue contains runnable network functions and the wait queue contains all idle network functions. The cooperative scheduler 164 offers a set of APIs that the network function runtime can use to transfer the ownership of network function processes of a network function chain from the CFS to the cooperative scheduler 164. These APIs are used by the agent 152, which runs as a privileged process. The network functions themselves cannot access these APIs, so the network functions cannot change scheduling priorities or core affinity.

Once a chain is deployed, all network functions are managed by the cooperative scheduler 164 and are placed in the wait queue as a detached state. Once a network function chain switches into the attached state, the cooperative scheduler 164 pushes the network functions of the chain into the run queue and ensures that the original network function dependencies are preserved in the run queue. To detach a network function chain, the cooperative scheduler 164 waits for the network function chain to finish processing a batch of packets, if any, and then moves these network function processes back to the wait queue.

Once a network function starts being executed by a worker node, such as the worker node 132a, the network function runtime reports the thread ID (tid) of the network function to the agent 152 running on the same worker. Once all network functions are ready, the agent 152 registers their tids as a scheduling group (sgroup) to the cooperative scheduler 164. Thereafter, the cooperative scheduler 164 takes full control of the network functions. When the controller 120 assigns traffic flows to a network function chain, the cooperative scheduler 164 attaches the chain to a core such as the core 154a. When the monitoring thread sees no traffic has arrived for the network function chain, the scheduler 164 detaches the network function chain, so the controller 120 can re-assign the core 154a.

To effect attach and detach operations, and to schedule network function chain execution, the cooperative scheduler 164 has a master thread for serving scheduling requests and runs one enforcer thread on each managed core. The cooperative scheduler 164 utilizes a key feature of Linux FIFO thread scheduling. Thus, high-priority threads preempt low-priority threads. A thread is executed once it is at the head of the run queue and is moved to the tail after it finishes. An enforcer thread is raised to the highest priority when enforcing scheduling decisions. When a network function chain is instantiated on a core, the enforcer thread registers the corresponding network function processes as low-priority FIFO threads so that they are appended to the wait queue. When attaching the network function chain, the enforcer thread network function processes to the run queue by assigning them a higher priority, and vice versa when detaching a sgroup. Operations are done in the sequence that network functions are positioned in the network function chain, so when a network function yields, the cooperative scheduler 164 automatically schedules the next network function in the network function chain.

In this model, each worker node splits CPU cores into two groups. One group is managed by the cooperative scheduler 164, while the other group runs with normal threads managed by the normal scheduler such as the CFS. A standard kernel is used and supports different schedulers on different cores. This enables running network functions and non-network functions workloads on the same worker node.

The cooperative scheduler 164 introduces N context switches for a chain with N network functions. Without packet batching, a core may incur significant context switch overhead. The example NFV platform 100 estimates the minimum batch size required to bound the context switch overhead within a fraction, p. The fraction, p, is configurable such as 5%. It is desirable to control the PCU time of running context switching to be less than or equal to the fraction, p, time the total CPU execution time. Without an appropriate batch size, the core may spend a significant portion of time on these context switches.

The example NFV platform 100 applies adaptive batch scheduling to bound the context switch overhead within a threshold of total CPU execution time. The minimum batch size is determined as follows. The matching batch size B for the chain is given by the following program.

Constraint (1) ensures the estimated rate to be within a ratio of the max rate:

$$r > = p \cdot \tilde{r} , where \tilde{r} = \frac{F}{{\sum }_{i = 1}^{N} {S}_{i}} . \qquad ( 1 )$$

\tilde{r} is the packet rate when running the NF chain in a single thread. This gives the maximum achievable rate. F is the processor clock frequency, and Sᵢ is the cycle count of the i-th network function in a chain needed to process a packet. The goal is to bound the downgraded maximum per-core packet rate within a ratio p of the maximum rate \tilde{r}. Ratio p is configurable in the example NFV platform. The objective function (2) finds the minimal batch size, B, fitting for the NF chain:

min B. (2)

Simple algebraic manipulations suffice to compute B. The actual packet rate is given by:

$$r = \frac{F}{{Σ}_{i = 1}^{N} {S}_{i} + \frac{N \cdot {C}_{ctx}}{B \cdot b}} \qquad ( 3 )$$

Where C_{ctx} is the context switch cost and B is the batch size.

The example NFV platform targets support for third-party network functions, such as a Palo Alto Networks firewall or a Snort IDS, in multi-tenant settings where each chain may consist of network functions from multiple vendors, and each chain may be responsible for processing traffic from a specific customer. In this scenario, the example Quadrant NFV platform 100 may ensure memory isolation as each network function may have its own private memory for maintaining network function state. The example NFV platform 100 may also ensure packet isolation as within a network function chain, a network function is not able to access a packet until its predecessor network function has finished processing the packet. Across chains, a network function is not able to access packets not destined to its own chain. Since each network function is encapsulated in a container, memory isolation for network function state is trivially ensured. The example NFV platform 100 uses shared memory to effect zero-copy packet transfers.

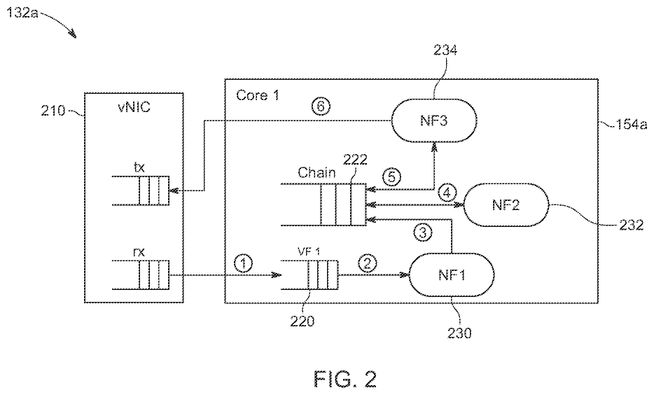

FIG. 2 shows the process of packet processing performed by one of the worker nodes such as the worker node 132a of the example NFV platform 100 in FIG. 1A. Since each network function is encapsulated in a container, memory isolation for network function state is ensured. This process achieves packet isolation while permitting (near) zero-copy transfers. As explained above, a virtual NIC 210 is formed by the NIC 150 of the worker 132a in FIG. 2A. In this example, a virtual function 220 is associated with a designated network function chain. A packet is initially tagged at the ingress module 124 in FIG. 1A. The L2 switch of the NIC 150 sends the packet to the NIC virtual function 220 associated with the network function chain such as the network function chain 222 that is the destination of the packet as tagged by the ingress module 124. The virtual function 220 directs memory accesses the received packet to the memory space of a first network function 230. After the packet processing function returns from the first network function 230, the packet is copied to the packet buffer of the network function chain 222 if there are other network functions. This is necessary to ensure packet isolation as the packet buffer of the NIC 150 should only be seen by the first network function 230. As explained above, the cooperative scheduler 164 for the core 154a controls the execution sequence of a second network function 232 and a third network function 234 to ensure temporal packet isolation. The final network function in the network function chain 222, which is the third network function 234 in this example, asks the virtual function to send the packet out from the virtual NIC 210. Shared packet memory for a network function is used to avoid packet copying whenever possible. The cooperative scheduler 164 controls the access to the shared memory to provide lightweight isolation.

The example NFV platform 100 allocates a separate virtual NIC with Single-root Input/Output Virtualization (SR-IOV) for each distinct network function chain. The example NFV platform 100 initializes each virtual NIC with a separate ring buffer queue that holds packets destined to the chain. Once a packet arrives, the NIC hardware can directly DMA packets to this packet queue as explained above in FIG. 2. Ideally, network functions within the network function chain may want to access the queue directly in the shared memory region so that all network functions can process packets without copies. However, this can violate packet isolation because a downstream network function could access shared memory while the NIC hardware writes to the shared memory.

To avoid this situation, the example NFV platform 100 gives only the first network function in the network function chain access to the NIC packet queue, and also allocates a second packet queue for each network function chain. This second queue holds packets for downstream network functions in the chain and is shared among those network functions. Thus, the first network function can access the NIC packet queue and is spatially isolated from other network function chains and from downstream network functions. The first network function processes a batch of packets and copies each batch to the second packet queue for the subsequent network functions.

The example NFV platform 100 then temporally isolates the second packet queue across all downstream network functions through cooperative scheduling. Cooperative scheduling ensures network functions run in the order they appear in the chain, so even though a downstream network function has access to shared memory, the downstream network function cannot access a batch that has not been processed by an upstream network function since it will not be scheduled. This permits zero-copy packet transfer between all network functions except the first network function.

For a chain with only one network function, the example NFV platform 100 omits the unnecessary packet copying and cooperative scheduling. The network function runtime also applies an optimization that prefetches packet headers into the L1 cache before calling the user-defined network function for processing tasks. This optimization can improve performance significantly. Finally, the example NFV platform 100 allocates packet queues for each network function chain and does not share queues across network function chains. This ensures spatial packet isolation across different network function chains.

Auto-scaling may need to allocate a new worker node to network function chain. Cold-starts can incur significant delay, especially since the example NFV platform uses user-space networking libraries that can incur 500 ms or more to set up memory buffers. This delay can result in SLO violations. The example NFV platform 100 keeps a pool of pre-deployed network function chains that start in the detached state and do not consume CPU resources.

The example NFV platform 100 is also resilient to network function failures. A network function monitor tracks liveness of each network function in a chain by tracking the progress of per-network function packet counters. The network function monitor is part of the runtime of the network function. Other components such as the controller 120, the agent 152, and the ingress module 124 are instantiated by Kubernetes, which manages their recovery. Once the controller 120 detects a failed network function, the controller 120 must migrate flows assigned to network function to another worker node. This is conceptually identical to the flow migration discussed herein.

The example NFV platform 100 auto-scales by automatically adapting resources allocated to network function chains in response to changes in traffic volume. FaaS controllers interact with the global ingress module 124 and the worker nodes 132a, 132b, 132n, in FIG. 1A to coordinate auto-scaling. The ingress module 124 dispatches incoming requests to idle instances on worker machines such as the worker node 132a. The FaaS controller manages the pool of instances to handle dynamic traffic while achieving cost efficiency.

The example NFV platform 100 employs a similar architecture, modified to satisfy performance and isolation goals. NFV workloads typically have a SLO that specifies the target latency. The controller 120 is designed to serve dynamic traffic while meeting stringent latency SLOs. The controller 120 performs two functions: 1) balance load across the workers such as the workers 132a, 132b, 132n; and 2) create/delete instances of network functions at the workers 132a, 132b, 132n. In this, the controller 120 is assisted by the agents for each worker that monitor network function performance and interacts with the cooperative scheduler 166 to enforce scheduling policies.

Monitoring is critical for scaling network function chains. At each network function, the network function monitor collects performance statistics, including the instantaneous packet rate, NIC queue length, and the per-batch execution time. The packet rate is measured as the average processing rate of the whole network function chain. The NIC queue length is as reported by the NIC hardware. The network function monitor also estimates per-batch execution time by recording the global CPU cycle counter at the beginning and the end of sampled executions. The latency SLO of a network function chain is the upper-bound for the tail (defined as the 99th percentile) end-to-end latency. The end-to-end packet latency measures the total time that a packet spends in the NFV platform 100 and includes both the packet processing latency and the network transmission latency.

To avoid interfering with data-plane processing, the network function monitor runs in a separate thread and is not scheduled on a core running network functions. Each network function monitor maintains statistics and sends updates to the controller 120 only when significant events occur (to minimize control overhead), such as when queue lengths or rates exceed a threshold.

A scaling algorithm run by the controller 120 estimates end-to-end tail latency and the packet load to determine when to scale up or down. To estimate the end-to-end tail latency, the example NFV platform sums the p99th duration that a packet spends on a worker (the worker latency), and the p99th network transmission latency. The scaling algorithm estimates the worker latency as 2× the p99 per-batch execution time acquired from the monitoring service, as a packet may have to wait for the previous and current batch. The scaling algorithm uses a function of the throughput of the link for the network transmission delay and use offline profiling to map throughput of a worker to the p99 network transmission latency.

To profile network transmission latency, two servers are connected to a ToR switch, and traffic at one worker node is generated. The NIC of the worker node is configured to bounce all received packets to another worker node. The end-to-end latency was measured at the traffic generator, and the p99th latency was recorded at different packet rates. This profile captures the link transmission and queuing delay at the switch and NIC queues at different throughputs.

The end-to-end latency estimation is conservative because the worker latency is the worst-case latency and the p99th end-to-end latency is less than or equal to the sum of the p99th worker latency and network transmission latency. The example NFV platform 100 also measures the packet load as the ratio between the current packet rate and the maximum packet rate. Queuing theory indicates that the queuing delay can skyrocket when the arrival rate gets close to the service rate. The example NFV platform 100 tries to avoid scheduling a chain close to its maximum rate because a small rate increase can significantly increase the latency. The example NFV platform 100 stops assigning more flows to a chain if its packet load exceeds a limit such as 90%.

In a typical deployment of the example NFV platform 100, such as on an edge of an ISP, the traffic aggregate hitting a network function chain is likely to exceed the processing capacity of a single core. In general, then, multiple instances of a network function chain might be deployed across the worker nodes 132a, 132b, 132n, in the example NFV platform 100. The load-balancer component interacts with the ingress module 124 to split flows among the deployed network function chains.

The ingress module 124 implements load balancing decisions made by the controller 120. The ingress module 124 adapts existing load-balancers to ensure flow consistent forwarding decisions. To do this, the ingress module 124 pre-fetches a list of worker core pairs from the controller 120, and their associated load, to assign to new traffic flows. When a new traffic flow arrives, the ingress module 124 assigns it to a worker node based on the associated load and installs a flow entry. These actions can be implemented either in hardware or software.

In a rack deployment of the hardware for the example NFV platform 100, all worker machines such as the worker nodes 132a-132n are on a rack and connected to a ToR switch on the rack such as the ToR switch 130. External traffic enters the rack holding the worker cluster 114 at the ToR switch 130. When a new flow hits the ToR switch 130, it does not match any rules, so the ToR switch 130 forwards the flow to the ingress module 124 through a switch port. In this example, the ingress module 124 may be software running on a worker node or another server. The ingress module 124 then makes a flow-assignment query to the controller 120 to select a network function chain to assign to this flow. The ingress module 124 then installs a flow entry on the ToR switch 130 to route subsequent packets of this flow to the worker node running the network function chain instance such as the worker 132a. To do this, the example NFV platform 100 relies on L2 tagging to forward the flow to the virtual NIC of the worker node 132a. Such assignments at a flowlet (sub-flow) level result in better balance load in the face of different flow sizes. The example NFV platform can incorporate this optimization.

This approach incurs two sources of delay: rule installation and obtaining the flow-to-worker mapping from the FaaS controller. The example NFV platform 100 employs optimizations for each of these.

Flow installation latency can be high (hundreds of ms), so the ingress module 124 forwards packets until the flow entry is installed. To do so, the ingress module 124 maintains a local flow table synchronized with the flow table of the ToR switch 130. This ensures that the ingress module 124 applies the same flow rule for subsequent packets of a traffic flow. The ingress module 124 tracks its own packet processing delay and scales up to use more cores when the latency reaches a limit.

The controller 120 continuously pushes the identity of the worker node to the ingress module 124 to use for new flows for each network function chain. The ingress module 124 uses the worker node identity for the flow-to-chain mapping, instead of having to query the controller 120 the mapping for each new traffic flow. The controller 120 tracks the load on the worker node, pushing a new worker identity when the controller 120 needs to re-balance the load.

The example NFV platform 100 attempts to schedule network function chains on the fewest number of CPU cores that can serve traffic without violating SLOs. It does this by: (a) carefully managing flow-to-worker mappings; and (b) monitoring SLOs and migrating flows to avoid SLO violations.

The controller 120 uses the per-chain end-to-end latency estimation as the primary scaling signal to balance loads among workers to avoid SLO violations. The controller 120 uses a hysteresis-based approach to control the end-to-end latency under a given latency SLO, while maximizing core utilization. Tₛₗₒ is the SLO of the target chain. The example NFV platform 100 uses two thresholds: a lower threshold aTₛₗₒ; and an upper threshold βTₛₗₒ (0<α<β<1). The controller 120 only assigns new flows to network flow chains whose estimated end-to-end latency is less than the lower threshold. Of these, the controller 120 selects the network flow chain with the highest packet load based on the monitoring and scaling signals, thereby ensuring that the example NFV platform 100 uses the fewest cores. Finally, the controller 120 stops assigning new flows to a network flow chain whose estimated p99 latency is between the two thresholds.

Due to traffic dynamics, the estimated end-to-end latency of a network flow chain can exceed the upper threshold. If this is the case, the controller 120 migrates flows from this network flow chain to another network flow chain running on another core until the estimated end-to-end latency falls below the lower threshold. Migrating flows thus reduces the queuing delay.

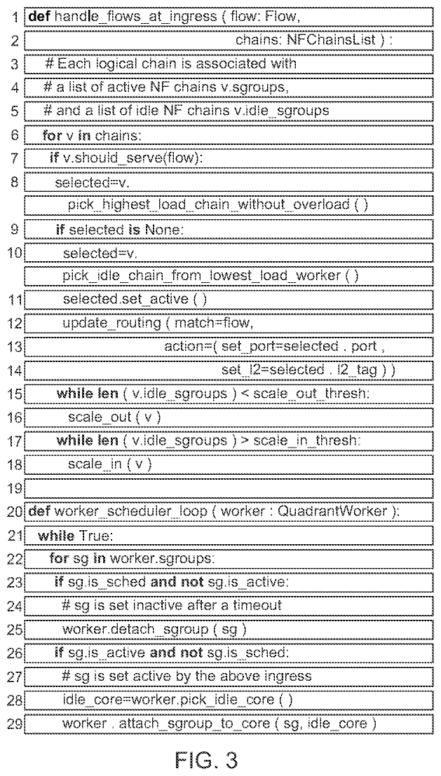

The runtime of the old worker node manages migration of stateful network functions to a new worker. The runtime on the old worker node synchronizes state with Redis before emitting packets in a batch. When a flow migrates to another worker, the runtime of the new worker node fetches state from Redis before processing packets from the batch. Finally, when a network function thread becomes idle as all flows previously assigned have been completed, the example NFV platform 100 reclaims the assigned core. The example NFV platform 100 may also migrate flows away from underutilized network function chains. FIG. 3 is pseudo code for the algorithms used at the ingress to assign traffic flows to network function chain instances, and the algorithms used at the cooperative scheduler of a worker to dynamically attach and detach cores from network function chains in response to traffic dynamics.

One example of the NFV platform 100 is built upon OpenFaaS having infrastructure and application layers for serverless functions. The infrastructure of the OpenFaaS uses Kubernetes, Docker, and the Container Registry. The example Quadrant NFV platform 100 reuses these APIs for managing and deploying network functions. For the application layer, OpenFaaS has its own gateway to trigger functions. The example NFV platform 100 adds the ingress module 124 to the existing gateway 112. Incoming traffic is split at the system gateway 112 where normal application requests are forwarded to gateway of the OpenFaaS while NFV traffic is forwarded to the ingress module 124. The OpenFaaS uses a function runtime that maintains a tunnel to the FaaS gateway, and hands off requests to user-defined functions. The example NFV platform 100 uses a different network function runtime by using the above mechanisms for receiving traffic from the ingress module 124. The example NFV platform 100 reuses the general monitoring framework of the OpenFaaS and relies on agents on each worker node such as the agent 152 on the worker node 132a for network function performance monitoring and enforcing scheduling policies. Thus, the additions to a OpenFaaS system are minimal.

The example NFV platform was tested by using a cluster of 10 Cloudlab servers, each with dual-CPU 16-core 2.4 GHz Intel Xeon® E5-2630 v3 (Haswell) CPUs with 128 GB ECC memory (DDR4 1866 MHz). Both DPDK and SR-IOV were configured for the cluster. To reduce jitter, all CPU cores had hyperthreading and CPU frequency scaling disabled. Each server had one dual-port 10 GbE Intel X520-DA2 NIC. Both are connected to an experimental LAN for data-plane traffic. Each machine had one 1 GbE Intel NIC for control and management traffic. The servers connected to a Cisco C3172PQs ToR switch with 48 10 GbE ports and Openflow v1.3 support. The traffic generator was used to generate simulated NFV traffic (consisting of many traffic flows) to the test platform. The traffic generator and the ingress module were run on dedicated machines.

Experiments with the example NFV platform 100 used end-to-end traffic with three canonical chains from light to heavy CPU cycle cost, from documented use cases. Thus, for the tests and experiments described below, Chain 1 implements a L2/L3 pipeline for tunneling: Tunnel→PForward; Chain 2 is an expensive chain with DPI and encryption NFs: ACL→UrlFilter→Encrypt; and Chain 3 is a state-heavy chain that requires connection consistency: ACL→NAT. Tunnel parses a packet's header, determines its VLAN TCI valueand appends a VLAN tag to the packet. ACL enforces 1500 access control rules. UrlFilter performs TCP reconstruction over flows, and applies complex string matching rules (e.g., Snort rules) to block connections mentioning banned URLs. Encrypt encrypts each packet payload with 128-bit ChaCha. NAT maintains a list of available L4 ports and performs address translation for connections, assigning a free port and maintaining this port mapping for a connection's lifetime.

Key performance metrics include: the end-to-end latency distribution and packet loss rate, and the time-average and maximum CPU core usage for the test duration. The traffic generator used BESS to generate traffic flows with synthetic test traffic.

As discussed above, the deployability of the example Quadrant NFV platform stems from the fact that very little code relative to the total size of these existing frameworks is added. The example Quadrant NFV platform adds code in three categories. The first category is code necessary for NFV service at the edge (independent of Quadrant), 4150 lines of code, including code for packet processing, monitoring, isolation, SLO-scaling, and core-reclaiming. The second category contains 1210 lines of code to support specific mechanisms of the example NFV platform, including isolation with shared memory and SLO-adherent chaining. The third category is 4200 lines of code to leverage standard APIs, including run-to-completion scheduling, supporting statefulness and FaaS packet processing interfaces, and cooperative scheduling. The rest of the example Quadrant code is for optional command line interface (CLI) and debugging tools. In comparison, the lines of code for OpenFaaS (345k), OpenLambda (217k), NetBricks (31k), Metron (30k for its control-plane), and SNF (20k) are relatively large. Thus, the example NFV platform only adds a very small fraction of lines of code to existing FaaS systems (2.7% of OpenFaaS). Further, the example NFV platform 100 uses less than half of lines of code compared to custom NFV systems because existing abstractions are reused judiciously.

Performance changes of the example NFV platform 100 when running network function chains of various lengths was examined. The per-core maximum of the example NFV platform 100 was compared with other NFV systems that make different isolation choices. For simplicity, a test network function of a Berkley Packet Filter (BPF) network function module with a table of 200 BPF rules was used. The BPF network function parses packet headers and performs 200 longest-prefix matches on packet 5-tuples. Chains were run with a sequence of the same test network.

The known EdgeOS NFV platform supports isolation via data copying. The EdgeOS was emulated on top of a reimplementation of NFVnice with the same set of mechanisms for packet copying, scheduling notifications, and cache-line optimizations. The master module of NFVnice was used to move packets between processes. The master module runs as a multi-threaded process with one RX thread for receiving packets from the NIC, one TX thread for transmitting packets among processes, and one wake-up thread for notifying a process that a message has arrived at its message buffer. All three threads run on dedicated cores to maximize performance.

The known NetBricks NFV platform uses compile-time language support from Rust to ensure isolation among network functions plus a run-time array bound check. The open-source implementation of NetBricks was used.

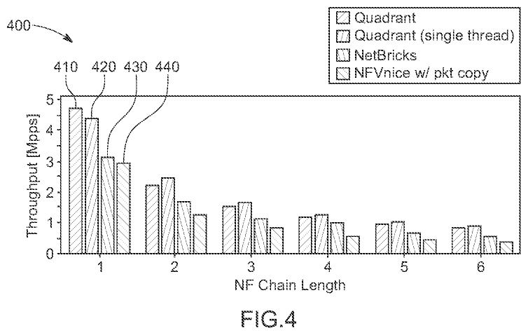

FIG. 4 is a graph that shows the throughput of different isolation approaches for different length chains. FIG. 4 shows bars 410 representing the throughputs of the example Quadrant NFV platform, bars 420 representing the throughputs of the example Quadrant NFV platform running a single thread, bars 430 representing the throughputs of the known NetBricks system, and bars 440 representing the throughputs of the known NFVnice with packet copy. As may be seen in FIG. 4, the example Quadrant NFV platform outperforms both NetBricks (1.21-1.51×) and NFVnice with packet copying (1.61-2.31×). NFVnice with packet copying achieves 62% throughput relative to the example NFV platform with a single-network function chain, but as chain length increases the throughput decreases despite the three extra CPU cores in NFVnice for transmitting packets among network functions. This is because of cross core packet copy overheads and load imbalance across network functions since NFVnice tunes scheduling shares for network functions on a single core using Linux's cgroup mechanism.

NetBricks suffers from memory access overheads due to array bounds checks. In the experiments, memory accesses were incurred during longest prefix matches. These overheads become significant when packets trigger complex computations, which explains the drop in performance. To validate this assertion, NetBricks was run with dummy network functions, that use an equivalent number of CPU cycles with no per-packet memory accesses. It was found that NetBricks can achieve 94-99% of the performance of the example NFV platform. By contrast, the lightweight isolation of the example NFV platform does not incur per-memory-access overheads, so it has higher throughput.

A variant labeled Quadrant (single thread) was tested that runs all network functions in a single thread to understand the overhead imposed by isolation. This variant offers no isolation because all network functions run in the same process. Throughput with increasing chain lengths was measured for running a network function chain on a single core when using 80-byte packets with neither language support for isolation nor the spatiotemporal packet isolation mechanism. Compared to this unsafe-but-fast variant, the example Quadrant NFV platform has an overhead that remains at the same level regardless of the chain length. As is shown in FIG. 4, the example Quadrant NFV platform achieves a 90.2%-94.2% per-core throughput when deploying a multi-network function chain while providing isolation. Thus, the example NFV platform pays a 6-10% penalty for achieving isolation. For a network function chain with one network function, the example Quadrant NFV platform achieves slightly better performance as it applies the prefetch-into-L1 optimization described in scaling of network function chains above.

The example Quadrant NFV platform scales chains to meet their latency SLOs. CPU core usage is quantified when deploying chains. The example Quadrant NFV platform was compared against Metron, a high-performance existing NFV platform, in the same end-to-end deployment setting. Metron auto-scales core usage, but does not support SLO adherence. E2 and OpenBox also have the same property, but Metron outperforms them, so the example NFV platform was compared only against Metron. Metron does not provide packet isolation, so Metron was not included in isolation comparisons.

Before each experiment, a network function chain specification was passed to the controllers of both systems to deploy network functions in the test cluster. Metron also uses a hardware switch to dispatch traffic and has its own CPU scaling mechanism. Unlike the example Quadrant NFV platform, Metron compiles network functions into a single process, and runs each chain as a thread to completion. Each Metron runtime is a multi-threaded process that takes all resources on a worker machine to execute chains with no isolation.

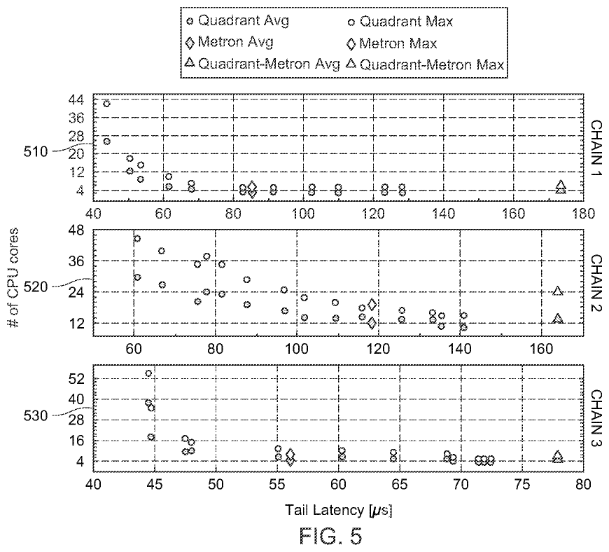

Across all experiments, both systems achieve a zero loss rate. Thus, the two systems are compared by looking at the tail latency and the CPU core usage when they serve the test traffic (100 million packets). The example Quadrant NFV platform can meet the tail latency SLO for all chains. In comparison, the Metron system targets zero loss, not SLO adherence. FIG. 5 shows a first graph 510 that plots the number of cores against the tail latency plots for the first chain. A second graph 520 plots the number of cores against the tail latency plots for the second chain. A third graph 530 plots the number of cores against the tail latency plots for the third chain. The graphs 510, 520, and 530 thus show the CPU core usage as a function of achieved tail latency by both systems. The Metron system does not adjust its CPU core usage for different latency SLOs, while the example Quadrant NFV platform is able to adjust the number of cores used to serve traffic under different SLOs, to trade off latency and efficiency. The example Quadrant NFV platform dedicates more cores for a stringent SLO.

To fairly compare CPU core usage, samples whose tail latency are smaller but closest to achieved latency of the Metron system were selected for the example Quadrant NFV platform. The time-averaged CPU cores were compared against those of the Metron system. For Chain 1, the example Quadrant NFV platform achieved 82.7 pts latency with 3.61 time-averaged cores, while Metron achieved 85.4 pts latency with 3.22 cores and thus the Quadrant NFV platform uses 12% more cores than Metron. For Chain 2, the example Quadrant NFV platform achieved 115.8 μs latency with 14.38 cores, while Metron achieved 118.3 μs latency with 11.66 cores and thus the Quadrant NFV platform uses 23% more cores than Metron. For Chain 3, the example Quadrant NFV platform achieved 55.9 μs latency with 6.29 cores, while Metron achieved 56.1 μs latency with 4.74 cores. The higher core usage results from the support for isolation of the example NFV platform and the SLO-adherence (both of which Metron lack), and the scaling algorithm that differs from Metron's. This overhead is reasonable as the example Quadrant NFV platform incurs multiple context switches in scheduling a chain.

With a tight latency SLO, the example Quadrant NFV platform uses smaller batch sizes, resulting in a higher amortized per-packet overhead. This can be more significant for light chains (e.g., Chain 3). However, the absolute number of extra cores remains small because such chains run at high per-core throughput. The monitoring in the example Quadrant NFV platform may notify users if chains have small batch size due to a stringent SLO. The example Quadrant NFV platform can relax the latency SLO or proceed with higher overhead.

To understand the impact of the scaling algorithm by itself, Metron's scaling algorithm was ported to the example Quadrant NFV platform, and a variant, called Quadrant-Metron was implemented. The graphs 510, 520, and 530 in FIG. 5 show the achieved latency and CPU core usage for this variant. Like Metron, the Quadrant-Metron variant does not adjust CPU core usage for different latency SLOs; for Chain 1, Quadrant achieved 128.4 μs, but Quadrant-Metron achieved 173.7 μs latency and uses 16% more cores on average. Similar results hold for other chains and validate the decision to design a new scaling algorithm instead of using the Metron algorithm.

The SLO-adherence in autoscaling different chains and with traffic dynamics of the example NFV platform was tested. For each experiment, a DPDK-based flow generator was run to generate traffic at 10 flows/s with a median packet size of 1024-byte. These values were selected through trace analysis. The traffic generator gradually increased the number of flows and reached the maximum throughput after 60 seconds, with a peak load of 18 Gbps. Then the traffic generator stayed steady at the maximum rate until 100 million packets were sent. All traffic entered the system through a switch. End-to-end metrics, including the tail latency, and the time-averaged number of cores for deploying chains were evaluated.

The example NFV platform scales chains to meet latency SLOs. The example NFV platform estimates the tail latency of a network function chain and uses it as a knob to control the end-to-end delay for packets being processed by the network function chains. The ability of controlling the end-to-end tail latency under different SLOs was evaluated for the example NFV platform with all test chains.

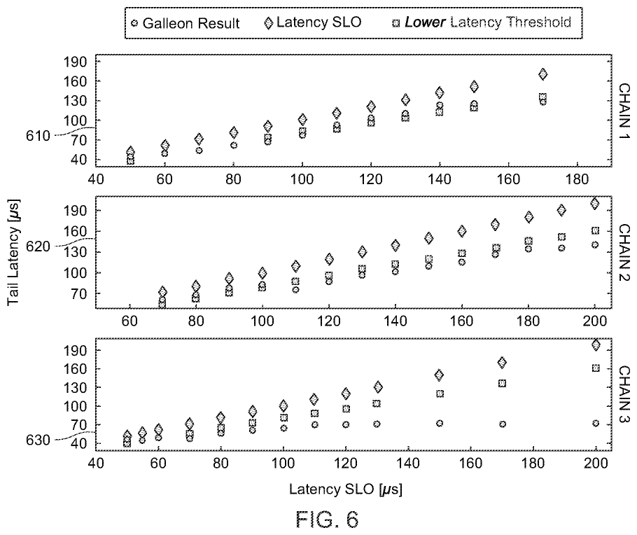

FIG. 6 shows the end-to-end tail (p99) latency achieved by the example NFV platform as a function of latency SLOs. FIG. 6 shows a first graph 610 that plots tail latency versus latency SLO for a first chain. A second graph 620 plots tail latency versus latency SLO for a second chain. A third graph 630 plots tail latency versus latency SLO for a third chain. For each chain, the example NFV platform is able to meet the tail latency SLO for all tested SLOs. At a higher latency SLO, both the lower latency threshold and the tail latency are higher because the controller 120 migrates flows from a chain when its estimated latency exceeds the higher latency threshold, and the controller 120 sets the lower threshold as the latency target.

This feature aligns with the trade-off between latency and efficiency. For a traffic input, achieving a higher tail latency results in a higher per-core throughput, which means the example NFV platform can devote fewer CPU cores to serve traffic. This unique feature is important in the FaaS context as the example NFV platform is able to use the right level of system resources to meet the latency SLO when deploying NFV chains.

From the graphs 610 and 620, Chain 1 and Chain 2 have tail latency close to lower latency thresholds. As shown in the graph 630, Chain 3 behaves differently as its tail latency stops increasing after its latency SLO is greater than 130 μs, because Chain 3 deployments have reached the per-core packet load limit. The example NFV platform avoids executing chains close to its max per-core packet rate. For these cases, the per-core rate is high enough so that it is less beneficial to pursue a higher per-core efficiency at the cost of making the end-to-end latency unstable.

It is important that the Quadrant NFV platform works for different traffic inputs. The ability to control latency with such inputs was evaluated for the example Quadrant NFV platform. To do so, chains with a fixed latency SLO were deployed to determine whether the example Quadrant NFV platform can control latency with traffic dynamics. Traffic dynamics were gradually increased by randomly accelerating a subset of flows by 30% of their packet rates for half of a flow duration. The percentage of flows with an increased packet rate was varied and the latency performance of the example Quadrant NFV platform was measured.

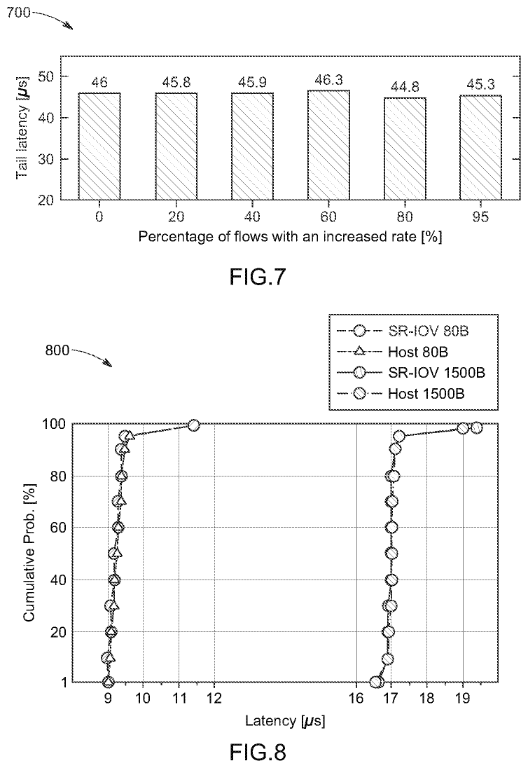

FIG. 7 is a graph 700 that shows the tail latency results under traffic inputs with different subsets of flows with an increased packet rate. The latency SLO is 70 μs. For all these cases, the example Quadrant NFV platform is able to meet the tail end-to-end latency SLO. In fact, as shown in the graph 700 all groups achieve similar latency results regardless of the input.

A breakdown of overheads of the example Quadrant NFV platform is shown, which come from spatiotemporal isolation. The overheads include the spatial isolation of a vNIC to isolate chains and packet copy from the buffer of the NIC to the buffer of the network function chain. The overheads also include the temporal isolation provided by transparent cooperative scheduling, with extra context switches among network functions unlike in a single process.

The spatial isolation overhead of the example Quadrant NFV platform was evaluated by quantifying SR-IOV overhead. This was performed by comparing running a test network function with and without the SR-IOV enabled. The test network function is an empty module so that it only involves swapping the dst and src Ethernet addresses of a packet to send it back.

FIG. 8 shows plots of different cumulative probabilities versus latency for the SR-IOV enabled and not enabled by the example NFV platform. The plots 800 in FIG. 8 show running with SR-IOV adds only 0.1 us latency for both 80-byte and 1500-byte packets. The maximum throughput achieved by an SR-IOV enabled NIC was greater than or equal to 99.6% of the throughput achieved by a NIC running in a non-virtualized mode.

Along a network function chain the ownership of a packet is transferred between network functions in the chain. Packet isolation requires that network functions in the same network function chain can only acquire packet ownership after its predecessor network function finishes processing the packet. To quantify this temporal isolation overhead, a multi-network function chain is used in which the first network function holds a NIC VF that is dedicated to this network function chain. The NIC hardware DMAs incoming packets to the NIC packet buffer that resides in the memory of the network function. The packet isolation requirement prevents other network functions from accessing the NIC packet buffer directly, as packets in that memory region are only destined to the first network function. For the rest of the chain, network functions share the access of a per-chain packet buffer and wait to be scheduled by the cooperative scheduler 164 to process the same batch of packets in the correct sequence.

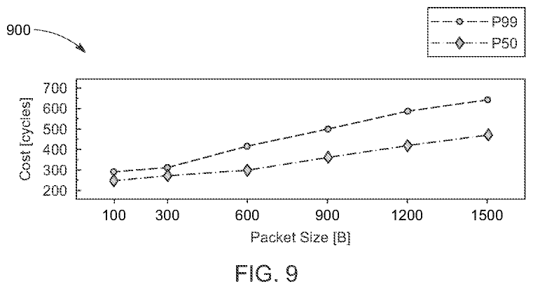

FIG. 9 is a graph 900 that shows the p50 and p99 CPU cycle cost for copying one packet of different sizes. The median cost to copy a 100-byte packet is 247 cycles and, for a 1500-byte packet is 467 cycles. This small difference is due to the cost of allocating a packet struct. Scheduling network functions cooperatively involves context switches between network function threads that belong to different network function processes. The average cost of context switches was profiled between network functions: 2143 cycles per context switch. This context switch cost is amortized among the batch of packets in each execution. For a default 32-packet batch, the amortized cost is only 67 cycles per packet. This cost is 27 14% of the cost for copying a 64∥500-byte packet respectively. Further, it is only 31% of the cost for forwarding a packet via a vSwitch with packet copying, as in NFVnice. The example Quadrant NFV platform has zero packet switching cost because it uses the ToR switch 130 and the L2 of the NIC 150 to dispatch packets to different chains

The example NFV platform may be scaled for larger capacity NICs. Cloudlab only supports OpenFlow for 10 GbE NICs so most of the tests used this NIC. However, the example NFV platform may scale to 40 or 100 GbE NICs. This is demonstrated by a set up of a separate two-node cluster. One node was the traffic generator and the other node as a worker of the NFV platform. The traffic generator is a dual-socket 20-core 2.2 GHz Xeon E5-2630. The worker is a dualsocket 16-core 1.7 GHz Xeon Bronze 3106. Both servers have one 100 Gbps single-port Mellanox ConnectX-5 NIC. The worker has one additional 40 Gbps single-port Intel XL710 NIC. They connect to an Edgecore 100BF-32X (32×100G) switch. As will be explained, the servers were used for experiments relating to scaling the concepts of the example NFV platform.

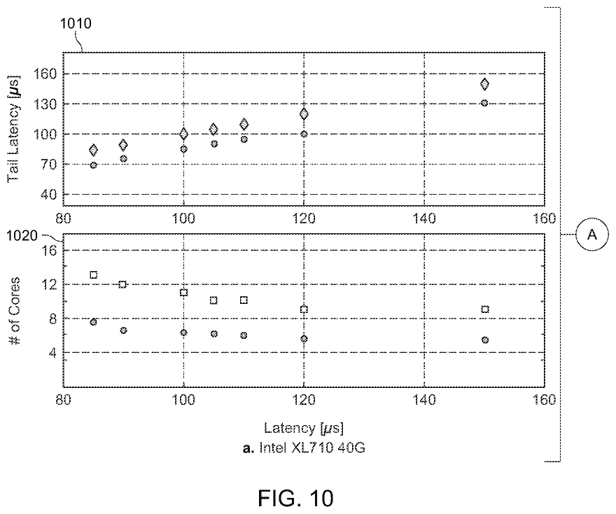

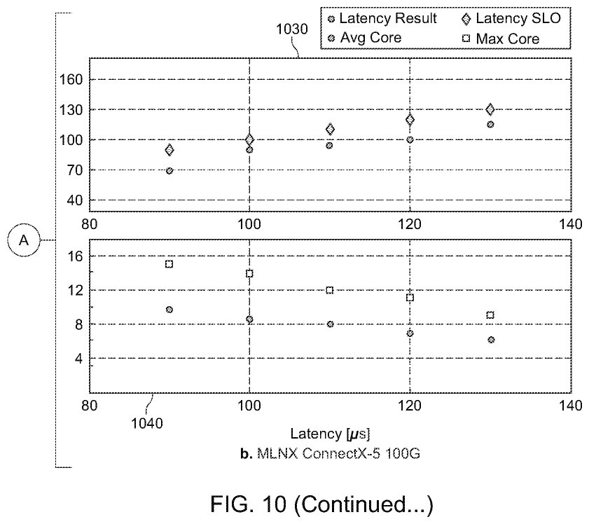

FIG. 10 shows a first graph 1010 that plots tail latency against latency for the 40 GbE NIC and a second graph 1020 that plots number of cores against latency for the 40 GbE NIC. A graph 1030 plots tail latency against latency for the 100 GbE NIC and a graph 1040 plots number of cores against latency for the 100 GbE NIC. FIG. 10 shows that, for Chain 1, the example Quadrant NFV platform is able, as before, to adjust the number of cores used to serve traffic for different latency SLOs, and utilize all available cores on the worker to meet stringent SLOs, both for 40 GbE and 100 GbE NICs. Chain 3 behaves similarly as Chain 1. Overall, these tests show that the design of the example NFV platform scales seamlessly at higher NIC speeds.

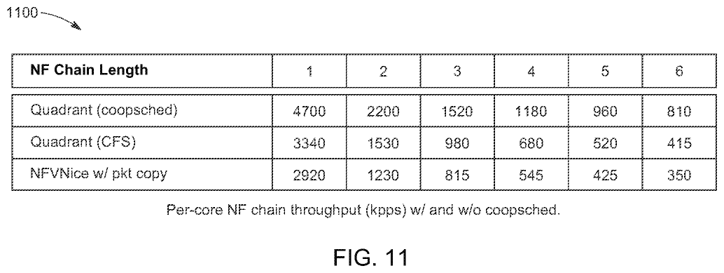

The cooperative scheduler enables packet isolation, even for network functions from third parties. A weaker form of isolation, assuming that network function can be trusted, can be achieved using the Linux CFS scheduler, together with explicit handoff from one network function to another using shared memory. This involves a network function setting a flag to indicate packets are ready to be processed by the next downstream network function. However, this weaker alternative is also slower than the cooperative scheduler 164 of the example NFV platform 100. FIG. 11 shows a table 1100 comparing the use of the cooperative scheduler 164 on the example NFV platform 100 with the NFV platform 100 using the known CFS scheduler and also with a known NFVNice platform using the known CFS scheduler. As shown in the table 1100, the example NFV platform using the cooperative scheduler 164 outperforms the example NFV platform using a CFS scheduler by 40.7-95.2%. In turn, the example NFV platform with a CFS scheduler still outperforms the NFVNice because the example NFV platform does not require expensive cross-core packet copying for each inter-network function hop.

For a chain, cooperative scheduling involves context switches between different network function processes. This operation can also flush caches and translation lookaside buffer (TLB)s. An experiment involving running the same test chain with 5 BPF modules was performed to determine context switches. The experiment was performed with four experimental groups: 1) a vanilla deployment of the example NFV platform without adaptive batch optimization; 2) the vanilla deployment that operates on one dummy packet in the shared memory region (Local Mem); 3) a chain of dummy network functions that does not process packets, but simulates network function cycle costs and 4) a chain that runs in a single thread. None of these groups use adaptive batch optimization so that they run with the same batch size. The traffic generator produced extra traffic (1024B packets) to saturate the NIC queue of the chain so that each chain runs at a batch size of 32, the default batch size of the NIC. The TLB and cache misses were measured as the average value for a 15-second execution duration for 5 measurements.

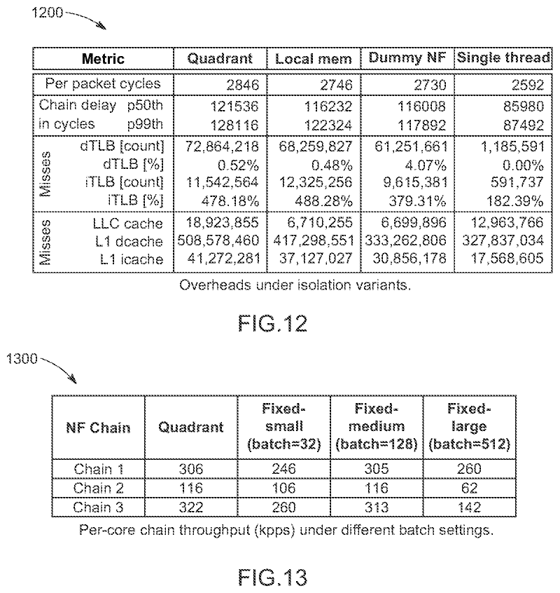

FIG. 12 shows a table 1200 of network function runtime statistics for each of the four groups. For all multiple process groups, there are higher iTLB and dTLB misses. As shown in the table 1200, the number of dTLB misses is less than 1% of dTLB hits for cases that run a non-dummy NF, though dTLB misses are less important for an NF's performance.

All multi-process groups see higher iTLB misses compared to the single thread case because network function processes do not share code in memory. The ‘local mem’ and ‘dummy NF’ cases perform similarly in terms of per-packet cycle cost (and the number of cache misses). This is because the ‘local mem’ case processes one packet that resides in the chain's local memory and is likely to benefit from the L3 cache. The ‘Quadrant’ case has a slightly higher per-packet cost compared to the other two multi-process cases. Breaking down per-chain cycle cost into the per-network function level, the extra cost only comes from the first network function that copies incoming packets. The second, third and fourth network functions in the Quadrant, Local Mem, and Dummy have the same cycle cost (509 cycles/packet). These network functions benefit from L3 caching as the runtime of the first network function loads when copying packets from the packet buffer of the NIC to the packet buffer of the chain.

In the above four cases, two major differences explain the per-chain cycle cost: a) iTLB misses when deploying as a multi-process chain and b) L3 cache misses when processing network traffic. The ‘Quadrant’ case has both; the ‘Local mem’ and ‘Dummy NF’ cases have a); and ‘Single thread’ has b). Cycle cost for each case was calculated via simple algebraic manipulations for the five network function chain: a) 254 cycles/packet (or 50.8 cycles/packet/hop); b) 100 cycles/packet. Among these two, a) is the extra overhead of a context switch, which could be reduced by tagged TLBs; b) is not an overhead as a chain may load packets into the CPU cache once when processing network traffic. Thus the amortized TLB overhead is relatively small compared to the context switch itself.

The example NFV platform uses batching to amortize context switching overheads and estimates an appropriate batch size for network function chain. The batching of the example NFV platform is shown by comparing the maximum per-core throughput produced and other schemes that use a fixed batch size for different chains. FIG. 13 shows a table 1300 that compares the batching on the three test chains performed by the example Quadrant NFV platform, and Fixed-small (using a small batch size of 32), Fixed medium (using a medium batch size of 128) and Fixed-large (using a large batch size of 512). The results in table 1300 show that batch setting of the example NFV platform performs significantly better than the three fixed batch settings. The example NFV platform always produces a throughput that matches the highest throughput among all experimental groups. Using a large batch size decreases per-core throughput of network function chains.

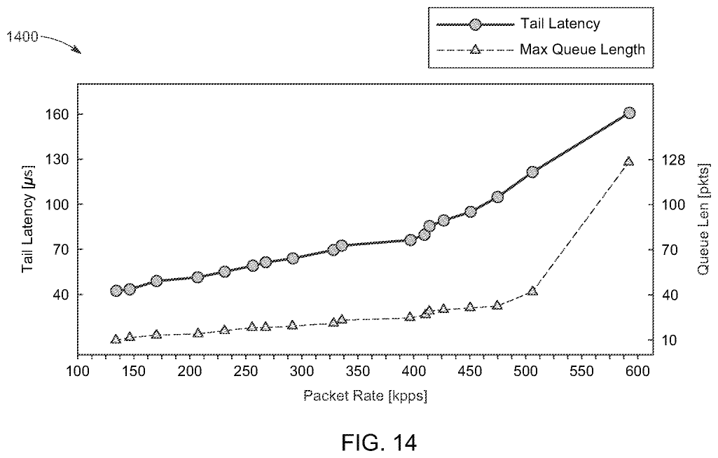

The scaling algorithm of the example platform was analyzed for sensitivity. The number of flows to be migrated was calculated. The example NFV platform migrates flows from a chain to reduce its packet processing latency, largely affected by the queuing delay. According to Little-law, the average packet queuing delay is calculated as d=1/(rₘₐₓ−r) where rₘₐₓ is the maximum packet rate that a chain runs on a core, and r is the current chain's packet rate. FIG. 14 shows a graph of the Chain 1 tail latency and per-core queue length as a function of the packet rate. In general, the queuing delay decreases as the packet rate decreases.

The slope of the queuing delay curve may be computed as:

$$\frac{δ d}{δ r} = \frac{1}{{( {r}_{max} - r )}^{2}} . \qquad ( 4 )$$

Equation (4) may be translated into the following form:

$$\frac{δ r}{r} = \frac{δ d}{d} = ( \frac{{r}_{max}}{r} - 1 ) . \qquad ( 5 )$$

where δr/r is the packet rate change ratio; δd/d is the latency change ratio; and the rate-adapting term

$$( \frac{{r}_{max}}{r} - 1 )$$

indicates that packet rate more is necessary for decreasing the latency by the same ratio when the packet arrival rate r is low.

With the above intuition, the sum of packet rates Δr for migrated flows as a function of the chain's current packet rate r_{curr} and its estimated latency t_{curr}. In this case, t_{curr}>βTₛₗₒ where Tₛₗₒ is the latency SLO; and βTₛₗₒ is the higher latency threshold. The example NFV platform uses the lower latency threshold αTₛₗₒ as the target latency for the migration, and calculate the sum of migrated flows' packet rates as:

$$Δ r = {r}_{curr} \frac{{t}_{curr} - α {T}_{slo}}{{t}_{curr}} ( \frac{{r}_{max}}{{r}_{curr}} - 1 ) . \qquad ( 6 )$$

Due to measurement errors, r_{curr} samples (calculated by using the packet counter of the chain) may be higher than rₘₐₓ (calculated by using the amortized per-packet cycle cost). To avoid a negative value, a hard limit 0.25 as the rate-adapting term's min value was applied, when r_{curr}>0.8rₘₐₓ.

In contrast, another simple solution is to migrate flows so that the aggregated packet rate is proportional to the latency change ratio without the rate-adjusting term. Both choices were evaluated with migration experiments. Traffic was generated to a chain and the latency estimation was increased to trigger a migration. It was checked whether the latency of the chain can drop by at least 50% of the expected value.

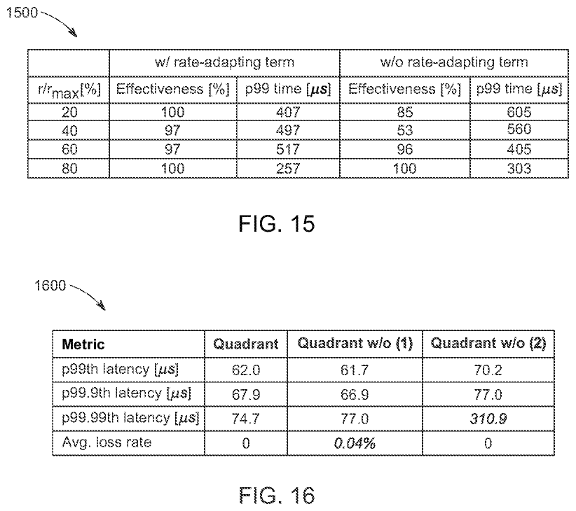

FIG. 15 is a table 1500 that lists migration results for Chain 1 under different traffic loads. The results in table 1500 show that it is necessary to apply the rate-adapting term to calculate the sum of packet rates for migrated flow. With the rate-adapting term, the example NFV platform can effectively reduce the latency of a chain for over 97% of migration events. Reduction of the latency fails for 15%-47% migration events at the low-throughput range when not applying a rate-adapting term. Also, it takes about at most 517 μs to observe a reduced latency for over 99% migrations. Therefore, duplicated flow migrations were avoided by setting the controller not to migrate flows twice for a chain within 520 μs in this setup.

The scaling algorithm works with a lower threshold (α) and an upper threshold (β) to assign flows and migrate flows from chains to avoid SLO violations as discussed above. Based on cluster-scale experiments, the thresholds were set as α=80%, β=90% of the chain's latency SLO. These values were adopted because they offer enough latency headroom to tolerant latency dynamics. For example, setting the thresholds as α=85%, β=95% can lead to a latency result close to the SLO. For Chain 1, the example NFV platform produced 109.3 μs latency for a 110 μs SLO. Adopting a pair of smaller thresholds can produce lower end-to-end latency, but results in an increased number of CPU cores in the deployment.

The impact of the two optimizations, ingress forwarding and push mapping, for the ingress module to mask sources of high latency was analyzed. To understand effects of both optimizations, Chain 3 was deployed to serve test traffic with the unmodified ingress, and the ingress implementations that turn off either ingress forwarding or push mapping. Key metrics include the overall packet loss rate, and the end-to-end tail latency. FIG. 16 shows a table 1600 that includes latency and loss results under 80 μs SLO for the example Quadrant NFV platform with both optimizations, without the ingress forwarding optimization, and without the push mapping optimization. The table 1600 shows that both optimizations on the ingress are necessary for achieving low tail latency and no packet losses. Turning off the ingress forwarding optimization results in losses, caused by the slow OpenFlow flow rule installation. Turning off the push mapping optimization results in a significant higher p99.99 latency caused by the slow flow-assignment query.

A complete failover event includes detecting a failed chain, recovering the network function chain state, and redirecting traffic to the new instance. The agent of the example NFV platform was configured to track network function liveness by checking the per-network function packet counter and software queue every 1 ms. This is sufficient for fast detection of failed network functions because the recovery time is dominated by other procedures. Chain 3 was run to study the recovery time for a stateful chain. Chain 3 was deployed to serve the test traffic and configure the controller to run chains at 50% packet load without a latency SLO. In the middle of the test, the network address translation (NAT) instance was failed and the time cost of the failover mechanism of the example NFV platform was analyzed.

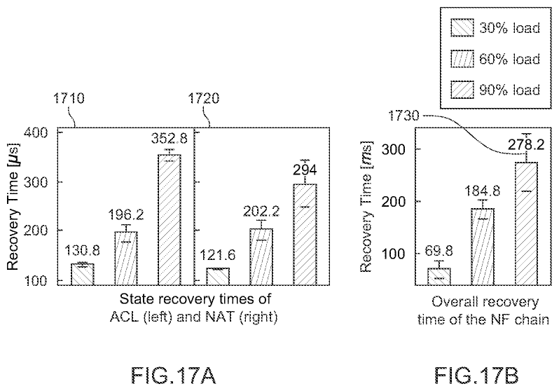

FIG. 17 shows a graph 1710 that shows the state recovery time for the firewall (ACL) and a graph 1720 that shows the state recovery time for the NAT for different loads. With a higher load it takes longer to recover all network function states from the remote storage service as there are potentially more states to migrate. For example, under a 90% packet load, it takes 353 μs and 294 μs to recover states for the firewall and the NAT respectively.

The overall chain recovery time measures the total time to recover a chain, from the start of a failure to the time when the new chain's packet rate recovers to its previous state. A graph 1730 shows the overall recovery times for different loads. The graph 1730 shows that this metric is significantly higher than the state recovery time. The recovery takes 69 ms, 184 ms, and 273 ms to completely recover a failed chain as a working chain. The overall chain recovery time is dominated by the flow-redirection operation. FTC, a state-of-the-art network function fault tolerant solution, reports similar recovery time of ˜100 ms-320 ms for NAT and firewall. Unlike these systems, the approach of the example NFV platform to failure handling and straightforward network scheduling scheme eases the task of preserving network function states.

The chain recovery process is transparent. The end-to-end tail latency for packets processed by this chain was compared. Average latency numbers are 38.73 μs, 43.37 μs, and 61.60 μs under 30%, 60%, and 90% loads before the chain fails, while latency numbers are 38.87 μs, 43.57 μs, and 62.17 μs after the chain is recovered.

The example Quadrant NFV platform supports NFV in edge and cloud computing environments using commodity software and hardware, fulfilling the original ambitions of NFV. The example NFV platform minimally extends FaaS abstractions and eases the deployment of third-party network functions. With spatiotemporal packet isolation, the example NFV platform outperforms state-of-the art NFV platforms that use alternative isolation mechanisms, and has performance comparable to custom NFV systems that do not provide network function isolation.

The example NFV platform is cloud-deployable and concurrently supports several functional and performance requirements such as: 1) chaining multiple, possibly-stateful third-party network functions to achieve operator objectives; (2) network function-state and traffic isolation between mutually-untrusted, third-party network functions; (3) near-linerate, high-throughput packet processing; and (4) latency and throughput SLO-adherence. In addition, the example NFV platform substantially reuses cloud computing infrastructure and abstractions.

Computer and Hardware Implementation of the Disclosure

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. In one or more embodiments, computer-executable instructions are executed on a general purpose computer to turn the general purpose computer into a special purpose computer implementing elements of the disclosure. The computer executable instructions may be, for example, binaries, intermediate format instructions such as assembly language, or even source code. Although the subject matter has been described in language specific to structural marketing features and/or methodological acts, it is to be understood that the subject matter defined in the appended claims is not necessarily limited to the described marketing features or acts described above. Rather, the described marketing features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as an un-subscription model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing un-subscription model can be composed of various characteristics such as, for example, on-demand self-service, broad network access, resource pooling, rapid elasticity, measured service, and so forth. A cloud-computing un-subscription model can also expose various service un-subscription models, such as, for example, Software as a Service (“SaaS”), a web service, Platform as a Service (“PaaS”), and Infrastructure as a Service (“IaaS”). A cloud-computing un-subscription model can also be deployed using different deployment un-subscription models such as private cloud, community cloud, public cloud, hybrid cloud, and so forth. In this description and in the claims, a “cloud-computing environment” is an environment in which cloud computing is employed.

In one example, a computing device may be configured to perform one or more of the processes described above. the computing device can comprise a processor, a memory, a storage device, an I/O interface, and a communication interface, which may be communicatively coupled by way of a communication infrastructure. In certain embodiments, the computing device can include fewer or more components than those described above.

In one or more embodiments, the processor includes hardware for executing instructions, such as those making up a computer program. As an example and not by way of limitation, to execute instructions for digitizing real-world objects, the processor may retrieve (or fetch) the instructions from an internal register, an internal cache, the memory, or the storage device and decode and execute them. The memory may be a volatile or non-volatile memory used for storing data, metadata, and programs for execution by the processor(s). The storage device includes storage, such as a hard disk, flash disk drive, or other digital storage device, for storing data or instructions related to object digitizing processes (e.g., digital scans, digital models).

The I/O interface allows a user to provide input to, receive output from, and otherwise transfer data to and receive data from computing device. The I/O interface may include a mouse, a keypad or a keyboard, a touch screen, a camera, an optical scanner, network interface, modem, other known I/O devices or a combination of such I/O interfaces. The I/O interface may include one or more devices for presenting output to a user, including, but not limited to, a graphics engine, a display (e.g., a display screen), one or more output drivers (e.g., display drivers), one or more audio speakers, and one or more audio drivers. In certain embodiments, the I/O interface is configured to provide graphical data to a display for presentation to a user. The graphical data may be representative of one or more graphical user interfaces and/or any other graphical content as may serve a particular implementation.

The communication interface can include hardware, software, or both. In any event, the communication interface can provide one or more interfaces for communication (such as, for example, packet-based communication) between the computing device and one or more other computing devices or networks. As an example and not by way of limitation, the communication interface may include a network interface controller (NIC) or network adapter for communicating with an Ethernet or other wire-based network or a wireless NIC (WNIC) or wireless adapter for communicating with a wireless network, such as a WI-FI.

Additionally, the communication interface may facilitate communications with various types of wired or wireless networks. The communication interface may also facilitate communications using various communication protocols. The communication infrastructure may also include hardware, software, or both that couples components of the computing device to each other. For example, the communication interface may use one or more networks and/or protocols to enable a plurality of computing devices connected by a particular infrastructure to communicate with each other to perform one or more aspects of the digitizing processes described herein. To illustrate, the image compression process can allow a plurality of devices (e.g., server devices for performing image processing tasks of a large number of images) to exchange information using various communication networks and protocols for exchanging information about a selected workflow and image data for a plurality of images.

It should initially be understood that the disclosure herein may be implemented with any type of hardware and/or software, and may be a pre-programmed general purpose computing device. For example, the system may be implemented using a server, a personal computer, a portable computer, a thin client, or any suitable device or devices. The disclosure and/or components thereof may be a single device at a single location, or multiple devices at a single, or multiple, locations that are connected together using any appropriate communication protocols over any communication medium such as electric cable, fiber optic cable, or in a wireless manner.

It should also be noted that the disclosure is illustrated and discussed herein as having a plurality of modules which perform particular functions. It should be understood that these modules are merely schematically illustrated based on their function for clarity purposes only, and do not necessary represent specific hardware or software. In this regard, these modules may be hardware and/or software implemented to substantially perform the particular functions discussed. Moreover, the modules may be combined together within the disclosure, or divided into additional modules based on the particular function desired. Thus, the disclosure should not be construed to limit the present invention, but merely be understood to illustrate one example implementation thereof.

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

Implementations of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer to-peer networks).

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described in this specification can be implemented as operations performed by a “control system” on data stored on one or more computer-readable storage devices or received from other sources.

The term “control system” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

1. A network function virtualization platform providing network functions for traffic flow of a network, the platform comprising:
a worker node including a core executing network functions, a scheduler, and an agent;
a first network function including code for executing the network function and a runtime;
an ingress module receiving network traffic flow and separating packets for performance of the first network function; and
a controller coupled to the ingress module and the agent, wherein the controller controls the ingress module to route the separated packets to the worker node, wherein the scheduler schedules execution of the first network function on the packets and the agent assigns execution of the first network function to the core of the worker node.

2. The platform of claim 1 wherein the network is a cloud computing infrastructure to support packet processing.

3. The platform of claim 2, wherein the cloud computing infrastructure is based on Function as a Service (FaaS) architecture, a Linux kernel, network interface card (NIC) hardware, and OpenFlow switches.

4. The platform of claim 1, wherein the first network function is stored in one of a container or a virtual machine accessible by the worker node.

5. The platform of claim 1, further comprising:
a plurality of worker nodes including the worker node; and
a router coupled to the plurality of worker nodes, the ingress module controlling the router to route packets to one of the plurality of worker nodes.

6. The platform of claim 5, wherein the controller collects network function performance statistics from agents of each of the plurality of worker nodes, and makes a load balancing decision based on the network function performance statistics as a basis to route packets to one of the plurality of worker nodes via the ingress module.

7. The platform of claim 6, wherein the load balancing decision is based on a service level objective (SLO) specifying a target latency.

8. The platform of claim 1 wherein the agent creates a network function chain of the first network function and the second network function, the network function chain instantiated on the core.

9. The platform of claim 8, wherein the worker node further includes a network interface card (NIC) forming a virtualized network interface function to exclusively direct assigned packets to the network function chain.

10. The platform of claim 8, wherein the scheduler sequences the first network function to process the packets and places the second network function in a wait queue, wherein the scheduler places the second network function in a run queue to process the packets only after completion of processing of the packets by the first network function.

11. The platform of claim 8, further comprising a memory region, wherein the first and the second network functions in the network function chain share the memory region, and wherein the memory region stores the incoming packets, and avoids copying the packets from the first network function to the second network function in the network function chain.

12. The platform of claim 1, wherein the worker node includes a plurality of cores including the core, and wherein the agent creates network function chains that each are executed by an assigned one the plurality of cores.

13. A method of performing network functions on traffic flow of a network, the method comprising:
receiving network traffic flow via an ingress module and separating packets for performance of a first network function, wherein the first network function includes code for executing the first network function and a runtime;
controlling the ingress module via a controller to route the separated packets to a worker node, wherein the worker node includes a core executing network functions, a scheduler, and an agent;
assigning execution of the first network function to the core via the agent;
scheduling execution of the first network function on the packets; and
executing the first network function via the core.

14. The method of claim 13, wherein the network is a cloud computing infrastructure based on Function as a Service (FaaS) architecture, a Linux kernel, network interface card (NIC) hardware, and OpenFlow switches.

15. The method of claim 13, wherein the worker node is one of a plurality of worker nodes including the worker node and wherein a router coupled to the plurality of worker nodes is controlled by the ingress module to route packets to one of the plurality of worker nodes.

16. The method of claim 15, further comprising:
collecting network function performance statistics from agents of each of the plurality of worker nodes; and
making a load balancing decision based on the network function performance statistics as to route packets to one of the plurality of worker nodes via the ingress module.

17. The method of claim 13 further comprising:
creating a network function chain of the first network function and the second network function, the network function chain instantiated on the core;
sequencing the first network function to process the packets via a scheduler;
placing the second network function in a wait queue; and
placing the second network function in a run queue to process the packets only after completion of processing of the packets by the first network function.

18. The method of claim 17, further comprising:
sharing a memory region between the first and the second network functions in the network function chain;
storing the incoming packets in the memory region; and
avoiding copying the packets from the first network function to the second network function in the network function chain.

19. The method of claim 17, further comprising:
creating network function chains;
assigning execution of the network function chains to one of a plurality of cores including the core of the worker node.

20. A non-transitory computer-readable medium having machine-readable instructions stored thereon, which when executed by a processor, cause the processor to:
receive network traffic flow and separate packets for performance of a first network function, wherein the first network function includes code for executing the first network function and a runtime;
route the separated packets to a worker node, wherein the worker node includes a core executing network functions, a scheduler, and an agent;
assign execution of the first network function to the core via the agent;
schedule execution of the first network function on the packets; and
execute the first network function on the core.
